(19) United States
(12) Patent Application Publication
(10) Pub. No.: US 2010/0326346 A1
(43) Pub. Date: Dec. 30, 2010

(54) Retractable Hazard and Boundary Marker

(76) Inventor: Gregory Allen Tapp, Mulberry, FL (US)

Correspondence Address: TUCKER LAW OFFICES, 61 RIDGEWAY DR, BROWNSBURG, IN, 46112, US

(21) Appl. No.: 12/491,076

(22) Filed: Jun. 24, 2009

(51) Int. Cl. G01D 21/00

(52) U.S. Cl. 116/209

(57) ABSTRACT

The present invention relates to a permanently placed retractable hazard and boundary marker. The hazard and boundary marker comprises a cylinder housing placed vertically beneath the ground or a playing, walking, or driving surface, and having an upper opening at or slightly above the ground or surface level. Said cylinder housing having an enlarged removable cylinder housing cap with a diameter greater than the cylinder housing attached to its upper opening. A retractable hazard and boundary marker rod is inserted through a hole in the center of the cylinder housing cap into the cylinder housing, allowing the rod to be lowered into the cylinder housing. The rod is elevated through the cylinder housing cap into a visible position by pulling on the widened top of the rod or a pull ring inserted through a hole bored into the top end of the rod. A stopper sleeve with a widened lip covers the lower end of the hazard and boundary marker rod and prevents the rod from being pulled completely through the cylinder housing cap.

### FIELD OF THE INVENTION

The present invention relates to hazard and boundary markers, and more particularly to hazard and boundary markers that may be lower into the ground to move them out of the way and protect them when necessary

### BACKGROUND OF THE INVENTION

For many years outdoor sporting events, nature trails, transient parking lots, and the like have had temporary markers in place to show individuals where the boundaries are in a sporting event, where the hazards are on a golf course or nature trail, and where an individual should drive and park at a temporary parking facility. Temporary facilities for cultural events and musical events also use temporary markers during those events for setting up booths and allowing the crowd to move in an orderly manner. Each time the facility or place in nature is used for an event that requires order, markers must be temporarily placed to show individuals how to proceed through the event and where the boundaries are located for the event.

Boundaries are places an individual ideally should not cross in order to stay in the field of play. Boundaries also keep individuals from trespassing. Markers also are used as hazard markers to warn individuals of areas of danger, or in the case of golf courses to show the golfer the location of a hazard such as water. Markers also are often used to show individuals where to park in a temporary parking lot, or where to drive in case of an emergency or evacuation.

In many cases an outdoor facility will be used only a few times a year. The markers for sporting events, cultural events, and musical events are removed during other times and stored until the next event. Temporary markers also are removed from temporary parking lots and stored until they are needed again. Each time an event occurs at a facility that is not used regularly, the markers must be placed back in the appropriate placed, which may take a tremendous amount of time and measurement. On a golf course every time the groundskeeper mows the course the hazard and boundary markers must be removed to allow the course to be mowed. The same problem applies to mature trails and ski resorts. Ski resorts and other like facilities have different sports for winter and summer. Boundary markers are constantly being places and removed according to the season and the sport for which the facility is used. The repeated placement and removal of hazard and boundary markers is time consuming and can wear on equipment over time. Storage of hazard and boundary markers also may be a problem if the storage space is not close to the place the markers are used, or if not enough storage space is available for the markers.

One solution to part of this problem is currently available. Markers already exist at facilities that have holders for the markers permanently attached to the ground or hard surfaces. This allows the portion of the marker that extends vertically to be removed and stored until needed again. The holder portion remains permanently in position above the ground. The facilities may be used for other purposes when the markers are removed. The positions of the holders do not have to be mapped out each time the markers are to be used again because the holders remain in their original positions.

Another solution to the problem is the flexible hazard and boundary markers used on some golf courses. This type of marker always remains in place to mark hazards and boundaries. It is flexible, which allows gold course equipment to run over the marker without breaking it. This type of marker does not have to be removed, which eliminates the need for a storage facility.

Thus present solutions solve one or the other of the problems with existing hazard and boundary markers, but not both. The solution of using removable markers does not do away with the need to storage of the vertical portion of the marker nor the time needed to remove that portion from storage and transport it to the holder that receives it. The other solution with the flexible marker allow the marker to stay in place. A flexible marker, however, will inevitably by broken by golf course equipment or will cause damage to the golf course equipment over time.

It is therefore an object of the present invention to provide an easily serviceable hazard and boundary marker.

It is another object of the present invention to provide a hazard and boundary marker that may be retracted to lower it out of the way when not in use, or when maintenance is needed above and/or around the hazard and boundary marker.

It is a further object of the present invention to provide a hazard and boundary marker that does not have to be removed from its location when not in use, eliminating the need for a storage facility for the hazard and boundary marker.

It is an additional object of the present invention to provide a hazard and boundary marker that does not require mapping of the hazard and boundary markers each time an event occurs, and each time grounds and other maintenance is done at the location of the marker.

It is another object of the present invention to eliminate the need for having to repeatedly physically place the hazard and boundary markers.

### SUMMARY OF THE INVENTION

The present invention provides a hazard and boundary marker which is both permanently placed and retractable. A cylinder housing extends into the ground or flooring surface, placing it beneath a playing, walking, or driving surface. The cylinder housing is oriented perpendicular to the ground or flooring surface. Attached to the opening of the cylinder housing closest to the floor or ground surface is an enlarged cylinder housing cap with a diameter greater than the diameter of the cylinder housing. The cylinder housing cap desirably is screwed onto the cylinder housing. The cylinder housing cap serves to keep grass and other objects away from the hazard and boundary marker.

The cylinder housing cap also allows the marker location to be easily identified when the hazard and boundary marker rod is retracted into the cylinder housing. A retractable hazard and boundary marker rod slides through the cylinder housing cap into the cylinder housing to allow the hazard and boundary marker rod to be lowered into the cylinder housing. The upper end of the hazard and boundary marker rod is fitted with a stopper to prevent grass, dirt, or other debris from entering the interior of the hazard and boundary marker rod. The stopper also acts as a grip to allow the hazard and boundary marker rod to be pulled through the cylinder housing cap into a visible position. An optional hole may be drilled through the upper end of the hazard and boundary marker rod and the stopper, and a pull-ring threaded through the hole to make elevation of the hazard and boundary marker rod easier. The hazard and boundary marker rod is held in an elevated position by a plastic sleeve inserted into the top opening of the cylinder housing providing enough resistance between the plastic sleeve and the hazard and boundary marker rod to allow the rod to stay in an elevated position. The plastic sleeve does not provide too much resistance, however, to prevent the hazard and boundary marker rod from being push back into a lowered position. Because the cylinder cap is screwed onto the cylinder housing, the functioning portions of the hazard and boundary marker are easily accessible and easily replaced when necessary.

Alternatively, as shown in FIG. 2 a magnet may be inserted into a hollow boundary marker rod and held in place by stoppers. A metal galvanized pipe threaded fitting then may be placed inside the top of the cylinder housing in place of the plastic sleeve to hold the hazard and boundary marker rod in an elevated position.

The hazard boundary marker rod of the present invention in general may be any size, shape, color, and have different designs placed upon it to allow it to serve as a marker for different purposes. The hazard and boundary marker rod may be hollow or solid.

The hazard and boundary marker of the present invention also may be used as a yard art support, a household or cemetery flag holder, and the like, by utilizing the hazard and boundary marker rod for support. The hazard and boundary mark rod also may be removed, allowing the remaining portion of the marker to hold the rod of the yard art or flag into the ground or other surface. The housing cap may optionally have a stopper placed into its central opening while not in use to prevent the cylinder from filling with water.

It is therefore an object of the present invention to provide an easily serviceable hazard and boundary marker.

It is another object of the present invention to provide a hazard and boundary marker that may be retracted to lower it out of the way when it is not in use or when course maintenance is needed above and around the hazard and boundary marker.

It is a further object of the present invention to provide a hazard and boundary marker that does not have to be removed from its location when not in use, thereby eliminating the need for a storage facility.

It is an additional objective of the present invention to provide a hazard and boundary marker that eliminates the need for mapping the location of the hazard and boundary markers each time an event occurs and/or each time grounds and/or other maintenance needs to be done at the location of the markers.

It is another object of the present invention to eliminate the need for repeated physical placement of the hazard and boundary markers.

### BRIEF DESCRIPTION OF THE DRAWINGS

A complete understanding of the present invention may be obtained by reference to the accompanying drawings, when considered in conjunction with the subsequent detailed description of the invention, in which:

FIG. 1 is a side perspective view of a retractable hazard and boundary marker in accordance with the present invention.

FIG. 2 is a side cross-sectional view of a hazard and boundary marker in accordance with the present invention.

FIG. 3 is a side cross-sectional view of a hazard and boundary marker with an elevated boundary marker rod in accordance with the present invention.

For purposes of clarity and brevity, like elements and components will bear the same designations and numbering throughout the Figures.

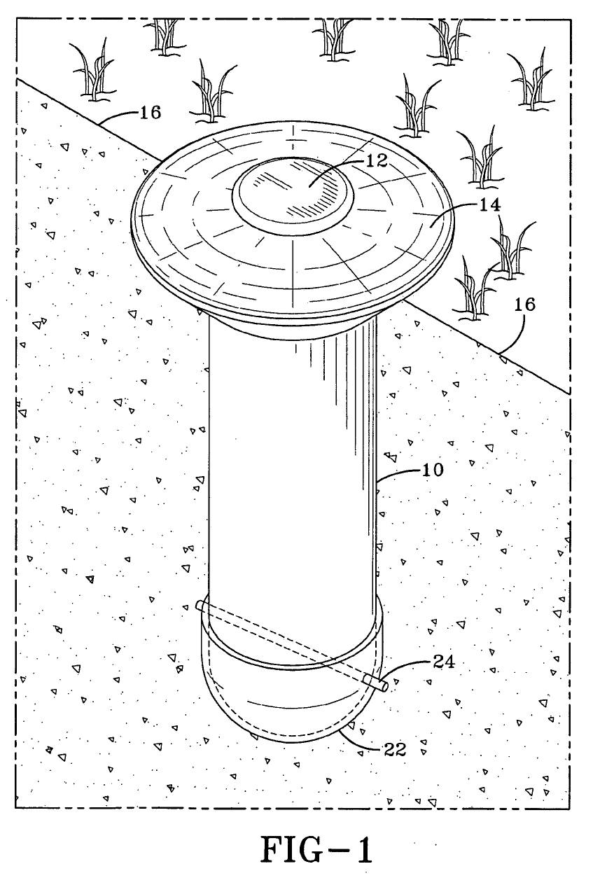

As shown in FIG. 1 the retractable hazard and boundary marker 1 of the present invention has a cylinder housing 10, or a housing of similar configuration. The cylinder housing 10 is desirably placed perpendicular to, and submerged beneath the ground or floor level 16, so that a cylinder housing cap 14 may be screwed on top of the cylinder housing 10 with the cylinder housing cap 14 level with or slightly below the ground or floor level 16. The cylinder housing cap 14 is removable to allow replacement of broken parts of the retractable hazard and boundary marker 1 as needed. The cylinder housing cap 14 ideally has a shape with the upper most part of the cylinder housing cap 14 being wider than the lower portion of the cylinder housing cap 14 to allow easy removal of the cylinder housing cap from the cylinder housing 10, easy replacement of the cylinder housing cap 14 back onto the cylinder housing 10. Alternatively, the cylinder housing cap 14 may be a truncated square pyramidal shape and have a circumferential flange perpendicular to the ground or flooring surface. Either shape of cylinder housing cap 14 will keep debris from falling against the cylinder housing 10 when the cylinder housing cap 14 is in place.

A bottom cap 22 having a closed rounded end, an inner diameter of a size to fit over the outer diameter of the cylinder housing 10, and an outer diameter greater than the outer diameter of the cylinder housing 10, is permanently fixed to the bottom end of the cylinder housing 10. As shown in FIG. 1 a peg 24 may be inserted through the rounded bottom of the cylinder housing 10, and in combination with the protruding upper edges of the bottom cap 22 keeps the cylinder housing 10 from readily being pulled out of the ground or flooring surface.

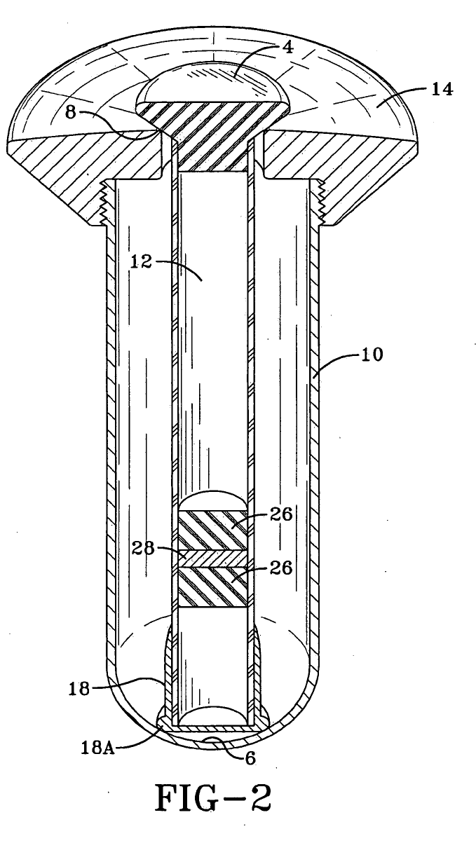

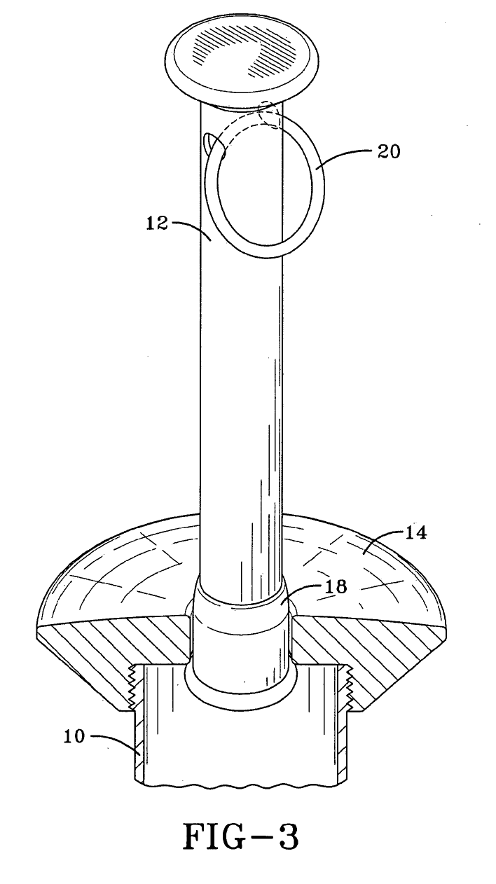

FIG. 2 is a side cross-sectional view of the retractable hazard and boundary marker 1 of the present invention showing the entire hazard and boundary marker rod 12. The hazard and boundary marker rod 12 extends through a hole 8 in the central portion of the cylinder housing cap 14, and extends to the floor 6 or close to the floor 6, of the cylinder housing 10. The hazard and boundary marker rod 12 has a stopper sleeve 18 enclosing the lower end of the rod 12. The closed bottom of stopper sleeve 18 has a widen lip 18a that prevents the hazard and boundary marker rod 12 from being removed through the central opening 8 of the cylinder housing cap 14. A stopper 4 having a widened lip on its top surface is inserted into the top opening of hazard and boundary marker rod 12. Optionally, a pull-ring 20 may be inserted through a hole bored through the hazard and boundary marker rod 12 and the stopper 4 as shown in FIG. 3. Each of the widened lip on stopper 4 and the pull-ring 20 kale raising the hazard and boundary marker rod 12 to its fully extended position easier. In addition, when hazard and boundary markers 1 are in place, a rope may be threaded through the pull-rings 20 in order to more fully define the hazard and/or boundary dimensions.

The stopper sleeve 18 and stopper 4 are removable and may be replaced as needed. The top of the hazard and boundary marker rod 12 may be straight sided as shown in FIG. 2 or alternatively may be widened at its upper surface as shown in FIG. 3 to allow an individual to more easily raise the hazard and boundary marker rod 12 to is fully extended position. The top widened portion of the hazard and boundary marker rod 12 may be made of one piece with the rest of the hazard and boundary marker rod 12 or may be a separate piece and fastened to the top of the hazard and boundary marker rod 12 with a screw or nut and bolt. The top widened portion of the hazard and boundary marker rod 12 may take various shapes as desired by the users thereof. In addition, an optional outer plastic sleeve of sufficient diameter to accommodate advertising logos, pictures, and/or text may be placed over the retractable hazard and boundary marker rod 12 in order to advertise a golf course or other venue, an event or event sponsor, and the like.

The cylinder housing 10, hazard and boundary marker rod 12, and cylinder housing cap 14 may be made of metal, hard plastics such as acetal or polyvinyl chloride, rubber, or other durable weather resistant materials, and the like. The cylinder housing 10, hazard and boundary marker rod 12, and cylinder housing cap 14 may be made in any shape that will allow the hazard and boundary marker 1 to perform its desired functions. For example, the cylinder housing cap 14 may be screwed onto the cylinder housing 10 as shown, or may be snapped in place, or may be made to open in a hinged fashion if desired. However the cylinder housing cap 14 is made, the cylinder housing cap must be easily removed to allow service of the hazard and marker 1.

The cylinder housing cap 14 may have a solid core or a hollow design if such a design will allow the cylinder housing cap 14 to perform its desired functions. The central hole 8 in cylinder housing cap 14 of FIG. 2 has a bevel on its top surface, which allows the beveled top surface of the hazard and boundary marker rod 12 shown in FIG. 3 to rest into the cylinder housing cap bevel. If the central hole 8 in the cylinder housing cap 14 has straight sides then the top edge of the hazard and boundary marker rod 12 also must have straight sides. A beveled cylinder housing cap 14 design reduces grass build-up around the hazard and boundary marker 1, if the hazard and boundary marker also has a matching tight fit bevel.

The hazard and boundary marker 1 in general may be of different lengths, shapes, sizes and colors according to its intended purpose. The hazard and boundary marker 1 also may be used as a yard art holder, yard flag holder, cemetery flag holder, and the like by using the hazard and boundary marker rod 12 for support. The hazard and boundary marker rod 12 also may be removed allowing the cylinder housing 10 to hold the rod of the yard art of flag above the ground or other surface.

While the present invention has been described in terms of a general embodiment and several specific embodiments, it is recognized that a person of ordinary skill in the field of hazard and boundary markers will readily perceive many modification and variations in the embodiments described above. Thus the present invention is not considered limited to the examples chosen for purposes of disclosure, and all such modification and variations which do not constitute departures from the true spirit and scope of this invention are included within the scope of the present invention.

What is claimed is:

1. A retractable hazard and boundary marker for marking hazards and boundaries when needed for golf courses, hiking and other trails, racing courses, parking areas, and other areas needing such markers, comprising:
a cylinder housing for a hazard and boundary marker rod, and acting as an anchor to hold a hazard and boundary marker rod in place;
a retractable hazard and boundary marker rod for warning individuals of hazards and boundaries;
a removable cylinder housing cap designed to fit over the open top of said cylinder housing and having a central hole for allowing movement of said retractable hazard and boundary marker rod through said central hole in said removable housing cap to raise or lower said hazard and boundary marker rod;
a binding sleeve stopper placed over the lower end of said hazard and boundary marker rod for holding said hazard and boundary marker rod in an elevated position, and for preventing said hazard and boundary marker rod from exiting through the opening in sain removable housing cap.

2. The removable cylinder housing cap of claim 1 wherein the upper portion of the cylinder housing cap is wider than the lower portion of the cylinder housing cap to allow easy removal and replacement of the cylinder housing cap on said cylinder housing.

3. The removable cylinder housing cap of claim 1 and 2 wherein the periphery of the central hole is beveled to match the bevel of the widened lip of the stopper inserted into the top opening of said hazard and boundary marker rod.

4. The cylinder housing of claim 1 having a threaded fitting at its upper opening for attaching the removable cylinder housing cap.

5. The cylinder housing of claims 1 and 4 also having a permanently attached bottom cap over the lower end of said cylinder housing, said bottom cap having a closed rounded end and an inner diameter slightly greater than the outer diameter of the cylinder housing, and an outer diameter greater than the outer diameter of the cylinder housing to prevent said cylinder housing being pulled out of the ground or other surface.

6. The retractable hazard and boundary marker rod of claim 1 having a removable stopper sleeve enclosing the lower end of said hazard and boundary marker rod; said stopper sleeve having a widened lip that prevents the hazard and boundary marker rod from being removed from the cylinder housing.

7. The retractable hazard and boundary marker rod of claims 1 and 6 having a stopper with a widened lip on its top surface inserted into the top opening of said hazard and boundary marker rod, said widened lip of said stopper being beveled to provide a water tight fit with the bevel of said central hole of said cylinder housing.

8. The retractable hazard and boundary marker of claims 1, 6, and 7 wherein the stopper has a widened lip on its top surface and/or a pull ring inserted through a hole bored through the hazard and boundary marker rod and the stopper to make raising the hazard and boundary mark rod to its fully extended position easier.

9. The retractable hazard and boundary marker rod of claims 1 and 6 through 8 wherein a removable outer plastic sleeve of sufficient diameter to accommodate advertising logos, pictures and/or text is placed over the hazard and boundary marker rod in order to advertise a golf course or other venue, an event, or event sponsor, or the like.

10. The cylinder housing, hazard and boundary marker rod, and housing cap of claims 1 through 9 when made of metal, hard plastics such as polyvinyl chloride or acetal, rubber, or other durable, weather resistant materials, and the like.
